(19) United States
(12) Patent Application Publication
(10) Pub. No.: US 2005/0202227 A1
(43) Pub. Date: Sep. 15, 2005

(54) Silane based coatings on glass fiber reinforcements in gypsum board

(76) Inventor: Richard Emil Kajander, Toledo, OH (US)

Correspondence Address: JOHNS MANVILLE;Legal Department, 10100 West Ute Avenue, Littleton, CO, 80127, US

(21) Appl. No.: 10/796,950

(22) Filed: Mar. 10, 2004

(51) Int. Cl. B32B 13/00

(52) U.S. Cl. 428/294.7

(57) ABSTRACT

A bond is created between a gypsum matrix and a silane-based sizing composition coated onto a glass fiber and gypsum matrix during manufacture of gypsum board. Hydrophilic water extraction at the gypsum matrix-sizing interface reduces void formation and promotes the growth of smaller calcium sulphate dihydrate crystals within larger calcium sulphate dihydrate crystals in microstructurally identifiable regions adjacent to the glass fiber. The resulting gypsum board exhibits excellent strength, flexure resistance and nail pull out resistance. An alternative approach utilizes a silane based sizing composition having branched chains that diffuse into a wet gypsum mix. During gypsum cure, the diffusion triggers formation of pseudo polymeric networks in a microstructurally identifiable region adjacent to the glass fiber. Bonds formed between the gypsum matrix and the silane based sizing composition increase the strength, flexure resistance and nail pull out resistance of the gypsum board.

### BACKGROUND OF THE INVENTION

1. Field of the Invention

The present invention relates to an improved gypsum board for use in building construction and to a process for its manufacture; and more particularly, to a gypsum board having a matrix including glass fibers coated with a silane sizing.

2. Description of the Prior Art

Gypsum wallboard and gypsum panels are traditionally manufactured by a continuous process. In this process, a gypsum slurry is first generated in a mechanical mixer by mixing either anhydrous calcium sulphate (CaSO₄) or calcium sulphate hemihydrate (CaSO₄.½H₂O, also known as calcined gypsum), or both, along with water and other substances, which may include set accelerants, waterproofing agents, reinforcing minerals, and glass fibers. The resulting gypsum slurry is normally deposited on a continuously advancing, lower facing sheet. Various additives, e.g. cellulose and glass fibers, are often added to the slurry to strengthen the gypsum core once it is dry or set. Starch is frequently added to the slurry in order to improve the adhesion between the gypsum core and the facing. A continuously advancing upper facing sheet is laid over the gypsum and the edges of the upper and lower facing sheets are pasted to each other with a suitable adhesive. The facing sheets and gypsum slurry are passed between parallel upper and lower forming plates or rolls in order to generate an integrated and continuous flat strip of unset gypsum sandwiched between the sheets. Such a flat strip of unset gypsum is known as a facing or liner. The strip is conveyed over a series of continuous moving belts and rollers for a period of several minutes, during which time the core begins to hydrate back to gypsum (CaSO₄.2H₂O). The process is conventionally termed “setting,” since the rehydrated gypsum is relatively hard. During each transfer between belts and/or rolls, the strip is stressed in a way that can cause the facing to delaminate from the gypsum core if there is not sufficient adhesion between the facing and the gypsum core. Once the gypsum core has set sufficiently, the continuous strip is cut into shorter lengths.

After the cutting step, the gypsum boards are fed into drying ovens or kilns to evaporate the excess water. Inside the drying ovens, the boards are blown with hot drying air. After the dried gypsum boards are removed from the ovens, the ends of the boards are trimmed off and the boards are cut to desired sizes. The boards are commonly sold to the building industry in the form of sheets, usually 4 feet wide, 8 to 12 feet long and 0.5 to 1 inches thick, the width and length dimensions defining the two faces of the board.

Wallboard formed of a gypsum core sandwiched between facing layers is used in the construction of virtually every modern building. In its various forms, the gypsum board is used as an interior or exterior surface for walls, ceilings and the like. The gypsum board is relatively easy and inexpensive to install, finish, and maintain, and depending on the composition of the gypsum matrix, may be relatively fire resistant. A number of patents discuss various reinforcement fibers and other hydrated matrices included in the gypsum matrix.

U.S. Pat. No. 4,241,136 to Dereser et al. discloses a process and composition for treating glass fibers for use in reinforcement of cementitious materials. The fibers are first sized with a cationic fiber forming organic polymer and then with a second coating containing an anionic film-forming organic polymer. The resulting fibers are said to have good wetting and dispersibility characteristics. The '136 patent suggests that the high surface charge density of asbestos fibers, in combination with a high specific surface area, permits them to flocculate cement mixed therewith, thereby providing a substantial degree of reinforcement to structural articles. However, replacement of asbestos fibers with glass is said not to have the expected benefit, in that the glass fibers tend to adhere together and thereby inhibit the removal of water during mat or board production. In addition, the much lower specific surface area of glass fibers results in poor retention of either cement or water thereon, in comparison with asbestos. The glass fibers do not have similar surface charges and the '136 sizing process is ineffective in bonding exclusively glass fibers without asbestos. The '136 sizing is not a silane based composition.

U.S. Pat. No. 4,349,610 to Parker discloses a method for improving the water repellency of a naturally porous, moisture-containing paper web by treating the web with a coating composition containing as its active coating ingredient an alkyl alkoxysiloxane which reacts with the moisture contained in the paper web to produce a polymer and an alcohol as a by-product. The polymer substantially improves the water repellency of the paper web while the web retains substantially the porosity and the strength characteristics it had in the untreated state. The coating composition attaches to paper, not to a glass fiber and makes the paper water repellant.

U.S. Pat. No. 4,710,405 to Griver et al discloses a method for improving the adhesion of silicone elastomers to substrates. The method comprises mixing an anionically polymerized polydiorganosiloxane, in the form of an emulsion that cures into a silicone elastomer upon removal of the water, and an amine functional polydiorganosiloxane co-oligomer of the formula 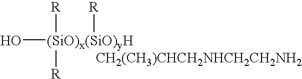
where R is a monovalent alkyl radical of from 1 to 6 carbon atoms, x is from 1 to 250, and y is from 2 to 50. The mixture is applied to a substrate and allowed to dry, to give a silicone elastomer adhered to the substrate in a cohesive manner. This silane based polymeric composition does not have capability of adhering to a glass fiber reinforcement or interacting with a gypsum matrix to create a bond between the glass fiber reinforcement and the gypsum matrix.

U.S. Pat. No. 4,824,890 to Glover et al. discloses film forming silicone microemulsions. A curable, reinforced polydiorganosiloxane microemulsion is prepared by adding from 5 to 30 parts by weight of colloidal silica per 100 parts by weight of polydiorganosiloxane in the microemulsion and from 1 to 5 parts by weight of dialkyltindicarboxylate catalyst per 100 parts by weight of the microemulsion to a polydiorganosiloxane microemulsion. The curable, reinforced polydiorganosiloxane emulsion can be cast into coherent, elastomeric films of less than 0.4 micrometer thickness. The '490 patent does not discloses a silane based composition that is added to a glass fiber and incorporated into a gypsum board.

U.S. Pat. No. 4,935,301 to Rerup et al. relates to a cement composite containing glass fibers encapsulated with a polymeric coating which is formed from an organic solution of an interpolymer complex of an anionic polymer and a cationic polymer. The fiber reinforcement is said to impart to the composite improved high apparent toughness, ductility, and flexural and tensile strengths, along with improved resistance to embrittlement and strength loss with age. The fibers are disposed in bundles which are encapsulated with an elastomeric material, wherein the encapsulant wraps the bundles of fibers but does not coat the individual fibers, nor does the coating impregnate the bundle or fill the voids between the individual fibers. The fibers are disposed in any cementitious matrix, including Portland cement, concrete, mortar, gypsum, and hydrous calcium silicate. There is no interaction between the polymeric encapsulant and the gypsum matrix nor does the polymeric encapsulant create a bond between the reinforcing fiber and the gypsum matrix.

U.S. Pat. No. 5,407,536 to Razac et al. provides improved glass fiber dispersions for making glass fiber mats by a wet-laid process. A small amount of an alkyl amidoalkyl sultaine surfactant is mixed with chopped glass fibers in water. The resulting dispersion may be formed at relatively high glass fiber concentrations, permitting high quality glass fiber mats to be made at high production rates. The glass fibers have a diameter of about 3 to 20 μm and are in the form of filaments or strands, generally chopped into bundles 0.5 to 3 inches long. The surfactant is present at a concentration of 5-500 ppm of solution. Alternatively, the glass fibers may be coated, e.g. by spraying, and subsequently dispersed in water. Use of other surfactants is also disclosed. The '536 patent discloses a surfactant that changes the wetting character of the glass fibers and does not coat individual glass fibers with a silane based sizing composition.

U.S. Pat. No. 5,429,839 to Graiver et al. discloses a method for grafting preformed hydrophillic polymers onto hydrophobic polymer substrates. Coatings of hydrophilic organic polymers, such as polyvinyl alcohol, are grafted to substrates formed from hydrophobic organic polymers and polyorganosiloxanes by exposing the surface of the substrate to an aqueous solution of the hydrophilic poller in the presence of a solubilized compound of tetravalent cerium that preferably contains hydroxyl or amino groups as ligands. The '839 patent discloses aqueous hydrophilic coating compositions for hydrophobic substrates formed from organic polymers or polyorganosiloxanes and does not disclose coating a silane based composition onto a glass fiber.

U.S. Pat. No. 5,786,080 to Andersen et al. discloses compositions and methods for the deposition of ettringite (3CaO-Al2O3.3Ca(SO4) 30-32H₂O) onto the surfaces of fibers, aggregates, or other fillers. The ettringite is produced in situ within an aqueous suspension while in proximity of the fibers, aggregates, or fillers, to form a mineralized composite material comprising ettringite coated fibers, aggregates or other fillers. The ettringite-coated materials can be added to hydraulically settable materials to improve the chemical and mechanical bond between the fibers or other substrate within the resulting hardened hydraulically settable materials, particularly cementitious or concrete material. The presence of the coated fiber materials is said generally to increase the toughness, flexibility, tensile strength, and flexural strength of the composite and articles made therefrom. It is indicated that the ability of fibers to modify the mechanical properties of a composite is dependent on the strength of the bonding between the fibers and the matrix material. The ettringite process is said to increase the roughness of the coated fibers, thereby enhancing the mechanical interlocking with the matrix over that achieved with relatively smooth glass fibers. The ettringite composition is an inorganic coating and not a silane based coating. In addition, the ettringite deposition does not result in a gypsum board that is flexure resistant or exhibits superior nail pull out.

U.S. Pat. No. 6,416,861 to Lee discloses organosilicon compounds and uses thereof. The '861 disclosure provides a compound of the formula: 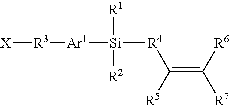
wherein

each of R.sup.1 and R.sup.2 is independently aryl, C.sub.1-C.sub.6 alkyl, or C.sub.3-C.sub.20 cycloalkyl; R.sup.3 is a bond or C.sub.1-C.sub.10 alkylene; R.sup.4 is C.sub.1-C.sub.10 alkylene; each of R.sup.5, R.sup.6 and R.sup.7 is independently H or C.sub.1-C.sub.6 alkyl; Ar.sup.1 is aryl or heteroaryl; and X is a functional group. The '861 disclosure provides synthesis of various silicone moieties for biological application. These compounds provide a variety of different functional groups upon which further chemical reaction can be performed to generate libraries of compounds. There is no disclosure in the '861 patent concerning application of silane based compositions to a glass fiber to improve interaction with a gypsum matrix.

U.S. Pat. No. 6,294,253 to Smith, Jr., discloses a sized, staple fiber product useful in the manufacture of gypsum board. The fiber surface is coated with an aqueous chemical size composition containing a high level of surfactant and optionally, a polymer film former and a biocide. The sized fibers may ultimately be incorporated as reinforcements in the gypsum core of a construction board. Preferred fibers are 5-23 μm in diameter and less than 1.5 inches long. The '253 patent disclosure does not apply a silane based sizing composition.

U.S. Pat. No. 6,521,086 is directed to a method of making a fiber-reinforced product such as a fiberglass reinforced gypsum board employing the sized staple fiber product delineated by the '253 patent.

Notwithstanding the advances in the field of gypsum boards and related articles, there remains a need in the art for a readily and inexpensively produced gypsum board having improved strength and flexure resistance with superior nail pull out resistance.

### SUMMARY OF THE INVENTION

The present invention provides a high strength, improved flexure resistant and improved nail pull out resistant gypsum board with glass fiber reinforcement that is bonded to the gypsum matrix through a silane based sizing composition. The sizing, having a thickness of 10 to 24 microns, is applied over the surface of glass fibers, attaching to the glass fibers through a hydrophobic moiety of the silane-based sizing. The hydrophobic moiety may be selected from the group consisting of amino, methacryl or alkyl functional groups. During manufacture of the gypsum board, the glass fiber coated with the silane based sizing is introduced into a wet gypsum slurry.

Hydrophilic moieties of the silane based sizing composition protrude into the wet gypsum mix and binds neighboring water molecules in the wet gypsum slurry. The hydrophilic moiety preferably is poly(ethylene) oxide. During a gypsum cure cycle, the binding of water molecules by the hydrophilic moiety reduces or prevents the formation of voids in the microstructurally identifiable region adjacent to the glass fiber as observed when the glass fiber does not have the silane based sizing. In addition, the removal of water from the microstructurally identifiable region after a gypsum cure cycle changes the crystal structure of calcium sulphate dihydrate in the region in that smaller crystals of calcium sulphate dihydrate are nucleated within interstices of larger crystals of calcium sulphate dihydrate. Thus, the microstructurally identifiable region adjacent to the glass fiber with the silane sizing shows a discretely different gypsum matrix microstructure than the region adjacent to the glass fiber without the silane sizing. The microstructure and the reduction of void formation in the microstructurally identifiable region results in a superior load transfer between the gypsum matrix and the glass fiber providing superior strength, superior flexure resistance and superior nail pull out resistance.

Hydrophobic moieties of the silane based sizing composition facilitates the firm attachment of the silane composition to the surface of the glass fiber. In one embodiment the silane based sizing composition has branched moieties capable of being cross linked when subjected to high temperature, due to the formation of T type cross links or Q type cross links. The silane based sizing composition with branched moieties is applied to the glass fiber, which is then added to the wet gypsum mixture during gypsum board manufacture. During the gypsum board cure cycle the multiple branched moieties cross link forming a pseudo polymeric network in the microstructurally identifiable region adjacent to glass fiber resulting in a gypsum matrix with decreased elastic stiffness. This reduced stiffness in the microstructurally identifiable region results in a superior load transfer between the gypsum matrix and glass fiber providing superior strength, superior flexure resistance and superior nail pull out resistance.

The gypsum board is produced in a manufacturing process wherein an aqueous slurry of wet gypsum is made by mixing at least one member selected from the group consisting of anhydrous calcium sulphate, calcium sulphate hemi-hydrate, hydraulic setting cement, and water. Glass reinforcement fibers coated with a silane based sizing composition may be incorporated into the wet gypsum mix during the mixing of the aqueous slurry. This wet gypsum mix slurry is cast onto a first facer placed on a moving belt. The silane coated fibers may also be laid in the form of organized structures, such as mats, incorporated at specific locations as layers within the cast wet gypsum mix. A second facer sheet is then placed on top of the wet gypsum mix slurry, creating a gypsum sheet. The sheet is cut into separate boards and dried in an oven during a gypsum cure cycle. The bond between the silane based sizing composition and the gypsum matrix occurs during this gypsum cure cycle.

### BRIEF DESCRIPTION OF THE DRAWING

The invention will be more fully understood and further advantages will become apparent when reference is had to the following detailed description of the preferred embodiments of the invention and the accompanying drawing, in which:

FIG. 1a is a cross-sectional view of a conventional gypsum board with small quantity of glass fibers used for flame resistance showing weak bonding between the glass fibers and the gypsum matrix and voids in the gypsum matrix caused by water evaporation during gypsum board manufacture;

FIG. 1b is an exploded view of the glass fiber gypsum matrix interface showing a poor bond between the glass fiber and gypsum matrix, with voids caused by evaporation of water during gypsum board cure;

FIG. 2a is a cross-sectional view of a gypsum board demonstrating one embodiment of the subject invention wherein a glass fiber coated with a silane based sizing with hydrophilic moieties bonds with a wet gypsum matrix, thereby reducing or eliminating local porosity around the glass fiber;

FIG. 2b is an exploded view of the near fiber region showing coupling between the sizing and the wet gypsum matrix due to the hydrophilic character of the silicone functional group termination;

FIG. 3a is a cross-sectional view of a gypsum board demonstrating a second embodiment of the subject invention wherein a glass fiber coated with a silane based sizing with branched moieties forms a hardened pseudo polymer network during gypsum cure; and

FIG. 3b is an exploded view depicting a narrow region adjacent to the fiber, wherein the wet gypsum mixture and the sizing diffuse into each other.

### DETAILED DESCRIPTION OF THE INVENTION

The present invention provides gypsum board and other hydraulic set and cementitious boards having glass fibers coated with a silane based sizing. The sizing is separately applied to individual glass fibers with the glass fibers forming a bond with the gypsum matrix during the curing of the gypsum board. The glass fibers coated with the silane based sizing may be incorporated into the wet gypsum mix during the mixing of an aqueous slurry. Alternatively, the silane coated glass fibers may be incorporated into the gypsum matrix in the form of organized structures, such as mats, as layers within the cast wet gypsum mix. Silane based sizing could be created from a variety of silane based compositions.

Gypsum board production has historically used low levels of sized glass fibers to provide fire resistance. In the absence of glass fibers the calcium dihydrate structure of gypsum boards starts to release the water of hydration at a temperature as low as 176° F. The boards subsequently lose strength and crumble due to loss of crystalline structure. In a fire event, the facer surfaces made of Kraft paper generally burn, resulting in the crumbling of the gypsum board. The glass fibers do not impart any strength or flexibility to the gypsum board since the glass fibers bond poorly to the gypsum matrix. Inadequate bonding is occasioned by the presence of voids created adjacent to the glass fibers in the gypsum matrix by the evaporation of water during gypsum cure.

Silane compositions are typically single or multiple strands of polydimethylsiloxane polymers. Each strand of the polydimethylsiloxane comprises a composition of the type Me₃SiO[Me₂SiO]ₙ SiMe₃, where Me is methyl group or (CH₃). Typically M represents (Me)₃SiO, D represents (Me)₂SiO and n represents number of D groups. The polydimethylsiloxane is more conveniently represented by the formula MDnM. Polydimethylsiloxane chains may be cross linked using a T member which is (CH₃)O₂Si or a Q member which is O₄Si. Silicone fluids are usually straight chains of polydimethylsiloxane (PDMS), which are terminated with a trimethylsilyl group (or groups). PDMS fluids come in all viscosity values—from water-like liquids to intractable fluids. The majority of PDMS fluids are essentially water insoluble. PDMS fluids may be further modified with the addition of organofunctional groups at any point in the polydimethylsiloxane polymer chain. Silicone gels are formed from lightly cross-linked PDMS fluids, where the cross-link is introduced either through a trifunctional silane, such as CH₃SiCl₃ giving a “T-branched” silicone structure, or through a chemical reaction between a silicon-vinyl group on one polymer chain and a hydrogen bonded to silicon on another polymer chain. This chemical “tying” of siloxane chains produces a three-dimensional network that can be swollen with PDMS fluids to give a sticky, cohesive mass without form. The basic structure of organofunctional silanes is: RnSi(OR)₄₋ₙ (with “R” being an alkyl, aryl, or organofunctional group and with “OR” being methoxy, ethoxy, or acetoxy). These chlorosilanes and organofunctional silanes may be oleophobic or hydrophobic for use in textile applications, as well as materials reinforcement coatings. Amino functional groups, commonly used as adhesion promoters, coupling agents, and resin additives, improve the chemical bonding of resins to inorganic fillers and may be used as reinforcing materials in polymeric systems such as epoxies, phenolics, melamines, nylons, PVC, acrylics, poly(olefins), poly(urethanes), and nitrile rubbers. Vinyl functional groups are used for cross-linking polyester, rubber, poly(olefins), styrenics, and acrylics and may be used to couple fiberglass to resins. In addition, vinyl functional groups can copolymerize with ethylene and graft to poly(ethylene) for moisture cure. Methacryl functional groups may also be used for coupling fillers or fiberglass to resins and provide moisture cross-linking of acrylics. Alkyl functional groups provide hydrophobic surface treatment of fillers and inorganic surfaces. Phenyl functional groups may also provide a hydrophobic surface treatment and may be used as a hydrophobic additive to other silane coupling agents.

In many applications, such as the placement of a sizing on a glass fiber, it is critical for the silicone product to stick (adhere) to the fiber. Whether the silicone is used as a coating, or an adhesive, a low-surface-energy polymer is being “stuck” to the glass fiber. It is achieved by carefully designing and formulating a silicone that bonds directly with the glass fiber substrate. Hydrophobic functional groups selected the group consisting of amino, methacryl and alkyl groups provide this bonding ability to the glass fibers.

Gypsum board production involves the hydration of calcium sulphate hemihydrate (CaSO4.1/2H₂O) and calcium sulphate anhydrite (CaSO4) forming a microcrystalline structure of gypsum (calcium sulphate dihydrate, CaSO4.2H₂O) in an exothermic water-of-hydration reaction. Gypsum expands slightly when forming the dihydrate (0.1 to 0.3%) with stronger gypsum products formed when less water is used during its production (typically 22 mls H₂O per 100 grams of powder vs. 50 mls H₂O per 100 grams of powder).

Since the gypsum manufacturing process is water based, the silicone polymer sizing must be designed to function in water-based processes and applications. Most silicone polymers are not water-soluble. For aqueous delivery, they are usually formulated as an emulsion—a dispersion of small droplets of silicone composition within an aqueous surfactant solution. Mechanical emulsification and emulsion polymerization also allow silicones that are difficult to handle or manufacture to be used with ease in an aqueous formulation or end application, eliminating the need for solvents to disperse the silicone polymers.

Although most silicone polymers are not water-soluble, there is an important class of water-soluble silicone surfactants. Surfactants are typically polymer molecules with two distinctive regions or “ends”—a hydrophobic (water-fearing) oil-soluble end and a hydrophilic (water-loving) water-soluble moiety. Such a molecule is very effective at stabilizing an oil-water interface. In the case of silicone surfactants, the silicone is the hydrophobic moiety, with the hydrophilic moiety often poly(ethylene) oxide. Silicone surfactants have unique properties, including wetting and emulsification behavior. Unlike many alkyl-based surfactants, they are active in organic media and can be used in either water or solvents.

There are two distinct approaches for imparting strength and flexibility to the gypsum boards by use of sized glass fiber reinforcement. The glass fibers are coated with a sizing based on silane chemistry. The glass fibers are coated with an appropriate silane composition prior to incorporation of the fibers within the wet gypsum mixture.

The first silane sizing approach comprises a 0.25 to 6 micron thick layer of a silane composition over the surface of a reinforcing glass fiber whereby the silane composition includes hydrophilic moieties having single or cross linked polydimethylsiloxane chains. The hydrophilic moiety preferably is poly(ethylene) oxide. Another hydrophilic moiety is poly(ethylene) imine. The hydrophobic moieties of the silane composition provides bonding functionality with the glass fiber and may be amino, methacryl or alkyl functional groups. The hydrophilic moiety of the silicone sizing dangles free in the aqueous medium and is free to interact with water molecule in the gypsum wet mix. The hydrophilic moiety of the silicone sizing absorbs water from the gypsum wet mix, thereby reducing the quantity of free water close to the fiber. When the gypsum matrix is cured during gypsum board curing cycle, the absorption of water by the silane composition results in a reduced amount of porosity, thus providing a better bond between the gypsum matrix and glass fiber. The overall gypsum matrix has to be porous enough to release excess water from the gypsum matrix in the form of water vapor. The reduced porosity close to the glass fibers results in improved load transfer between the gypsum matrix and the glass fiber resulting in a stronger and more flexure tolerant gypsum matrix. The effect of sequestering water by the silane composition results in a gypsum microstructure comprising larger calcium sulphate dihydrate crystals with smaller calcium sulphate dihydrate crystals surrounding the glass fibers. This microstructure results in improved load transfer between the gypsum matrix and the glass fiber.

The second silane sizing approach comprises an approximately 0.25 to 6 microns thick highly branched silicone sizing which is coated onto a fiber in an uncured state. The branches of the silicone sizing require a curing cycle to accomplish cross linking of branched PDMS chains. As with the single chain silane sizing the branched chain silicone sizing has hydrophobic moieties including amino, methacryl or alkyl groups which function to bond the silicone based sizing to the glass fiber. When the sizing coated glass fiber is introduced into wet gypsum slurry, the highly branched silicone sizing in the uncured state permeates freely into the wet gypsum mixture forming a pseudo interpenetrating polymer network within the gypsum matrix. The concentration of the silicone sizing in the gypsum matrix decreases exponentially as a function of distance from the glass fiber gypsum interface. The chemistry of the sizing is chosen so that the branched chains of the silicone sizing within the gypsum matrix cross links at essentially the same temperature as used in the cure conditions of the gypsum board. The silane coating penetrates the wet gypsum matrix in the unpolymerized state whereupon curing results in the polymerization of the silicone polymer. Alternatively, the silicone sizing may melt during the gypsum curing cycle and permeate the gypsum matrix during cooling create a polymer network in the gypsum matrix. This process forms a decreased modulus contact region and a mechanical link between glass and matrix capable of withstanding gypsum board flexure without fiber breakage. In addition, this contact results in improved load distribution between the gypsum matrix and the glass fiber resulting in better strength properties of the gypsum reinforced matrix.

Using these approaches, the sizing chemistry on glass fibers can be tailored to enable gypsum boards with superior dry-strength reinforcement and fire-resistant properties.

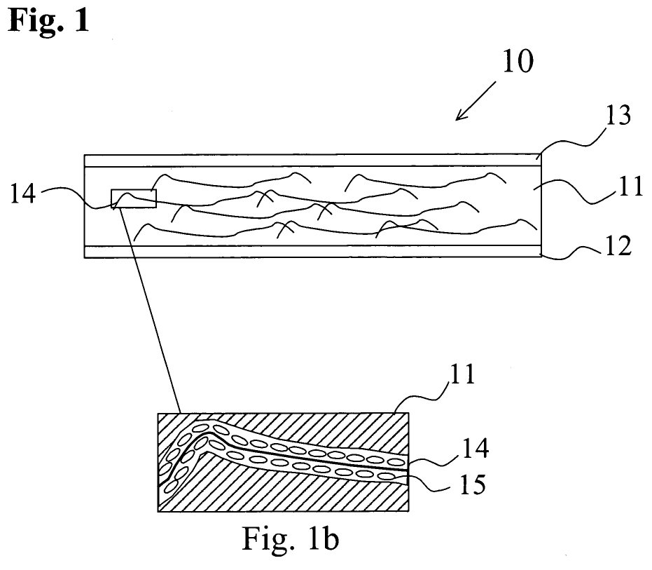

Referring to FIG. 1 of the drawings, there is shown generally at 10 a cross-sectional view of a conventional gypsum board with a gypsum matrix 11 incorporating a small quantity of glass fibers 14 used for providing flame resistance to the gypsum board. The gypsum board 10 has a first facer at the bottom at 12 and a second facer at top as shown at 13. The facer sheets are commonly made from Kraft paper. An exploded view of the glass fiber gypsum matrix interface is shown at FIG. 1b, showing poor bond between the glass fiber 14 and gypsum matrix 11 with voids 15 caused by evaporation of water during gypsum board cure. These glass fibers 14 are added to the wet gypsum slurry and are typically do not form a well laid out reinforcement structure. There is no load transfer between the gypsum matrix and the glass fiber and therefore, the glass fibers do not provide any strength or flexural resistance to the gypsum board. During a fire event, the face Kraft paper is burnt and the gypsum matrix loses water of hydration at approximately 176 F and crumbles to a powder. The glass fibers provide some structure and prevent the complete collapse of the gypsum board even though there is no residual appreciable strength by the gypsum board after a fire event.

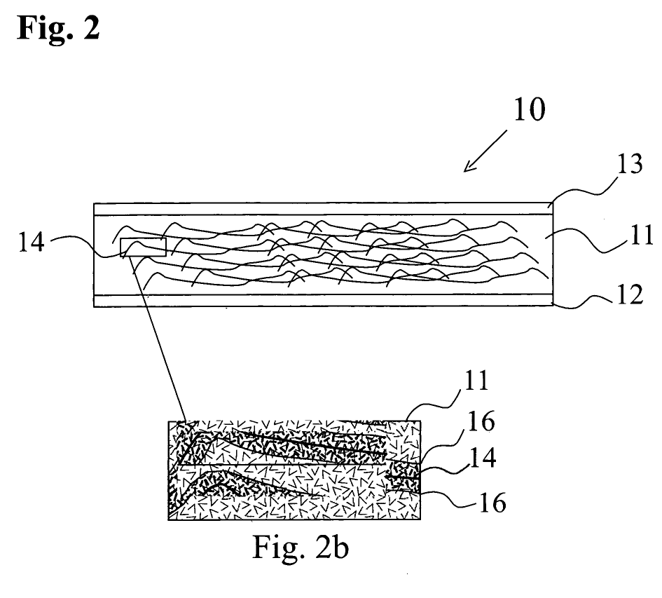

Referring to FIG. 2a there is shown a cross-sectional view of a gypsum board 10 manufactured according to one embodiment of the subject invention. A glass fiber 14 is coated with a silane based sizing composition. The sizing couples with a wet gypsum matrix in the region adjacent to the glass fiber. That region is indicated by 16 in the exploded view of the near fiber region shown at FIG. 2b. Coupling is due to the hydrophilic character of the silicone functional group termination. The hydrophilic character absorbs some of the water close to the fiber and the quantity of water vapor released during the gypsum cure is decreased, resulting in reduction or absence of void formation in the region, as shown at 16. Smaller crystals of calcium sulphate dihydrate are formed within larger crystals of calcium sulphate dihydrate crystals adjacent to the fiber due to this water absorption effect as shown at region 16. The gypsum board has a first facer sheet 12 and a second facer sheet 13.

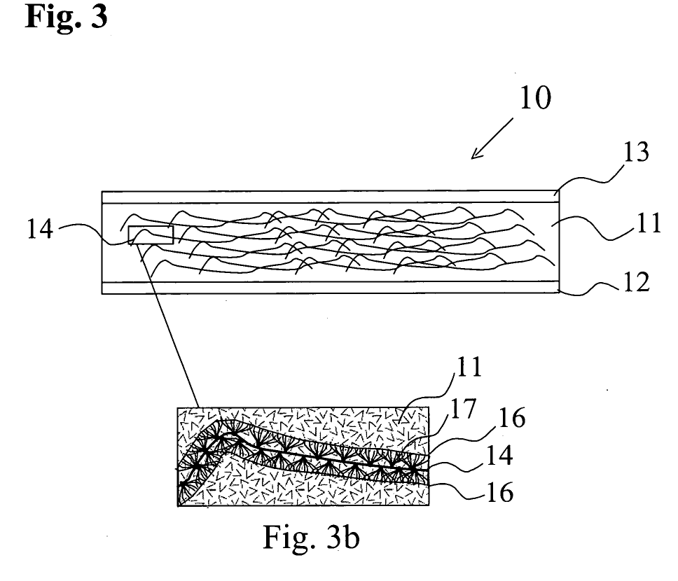

Referring to FIG. 3 there is shown a cross-sectional view of a gypsum board at 10 according to a second embodiment of the subject invention. A glass fiber 14 is coated first with a cross linking multi branched silane based sizing composition. When this sizing coated fiber is incorporated into a wet gypsum mix the wet gypsum mixture and the sizing diffuse into each other in a narrow region adjacent to the fiber. This narrow region is shown at 16 in FIG. 3b, which is an exploded view of the near fiber region. The gypsum cure results in cross linking of the multi branched silane based sizing composition resulting in a pseudo polymeric network 17 embedded within the gypsum matrix 11 adjacent to the glass fiber surface. The concentration of this pseudo polymeric network is highest next to the glass fiber and decreases exponentially as a function of the distance away from the glass fiber matrix interface. The pseudo polymeric network decreases the elastic modulus and stiffness of the gypsum matrix adjacent to the fiber resulting in a more compliant resilient matrix that transfers load to the glass fiber without fiber breakage.

The present improved gypsum board production method comprises the steps of: coating the glass fibers with a silane based sizing, laying fibers in the form or organized structures such as mats or keeping loose bundles of coated glass fibers, forming an aqueous slurry comprising at least one of anhydrous calcium sulphate, calcium sulphate hemi-hydrate, and hydraulic setting cement; mixing aqueous gypsum slurry with the loose bundles of coated glass fibers, distributing the aqueous slurry to form a layer on a first facing sheet, preferably Kraft paper; applying organized fiber structures within the slurry, applying a second facing sheet, preferably Kraft paper, onto the top of the layer; separating the resultant board into individual articles; and drying the articles. The product of the invention is ordinarily of a form known in the building trades as board, i.e. a product having a width and a length substantially greater than its thickness. Gypsum and other hydraulic set and cementitious board products are typically furnished commercially in nominal widths of at least 2 feet, and more commonly 4 feet. Lengths are generally at least 2 feet, but more commonly are 8-12 feet.

Having thus described the invention in rather full detail, it will be understood that such detail need not be strictly adhered to, but that additional changes and modifications may suggest themselves to one skilled in the art, all falling within the scope of the invention as defined by the subjoined claims.

1. A gypsum board, comprising:
a. a gypsum matrix having a bottom and a top;
b. a first facer sheet placed on the bottom of said gypsum matrix;
c. a second facer sheet placed on the top of said gypsum matrix;
d. one or more glass fibers placed within said gypsum matrix; and
e. a silane based sizing composition coating said glass fibers, said coating providing increased strength, flexure resistance and nail pull out resistance to said gypsum board.

2. A gypsum board as recited by claim 1, wherein each of said first and said second facer sheets comprises Kraft paper.

3. A gypsum board as recited by claim 1, wherein said gypsum matrix comprises calcium sulphate hemihydrate (CaSO4.1/2H₂O), calcium sulphate anhydrite (CaSO4), hydraulic setting cement and water.

4. A gypsum board as recited by claim 1, wherein said hydraulic setting cement is selected from the group consisting of Portland cements, sulphate resisting cements, blast furnace cements, pozzolanic cements, and high alumina cements.

5. A gypsum board as recited by claim 1 wherein said silane based sizing composition coating comprises polymethylsiloxane.

6. A gypsum board as recited by claim 1, wherein said silane based sizing composition includes a hydrophobic moiety whereby said hydrophobic moiety functions to cause said silane based sizing composition to adhere to said glass fibers.

7. A gypsum board as recited by claim 1, wherein said silane based sizing composition includes a hydrophilic moiety whereby said hydrophilic moiety interacts with water present in said gypsum mix.

8. A gypsum board as recited by claim 1, wherein said hydrophobic moiety is selected from a group consisting of an amino group, a methacryl group and an alkyl functional group.

9. A gypsum board as recited by claim 1, wherein said hydrophilic moiety comprises poly(ethylene) oxide or poly(ethylene) imine.

10. A gypsum board as recited by claim 1, wherein said silane based sizing composition comprises a plurality of silane molecules having single or cross linked polydimethylsiloxane chains.

11. A gypsum board as recited by claim 1, wherein said silane based sizing composition comprises a plurality of silane molecules having multi branched chains.

12. A gypsum board as recited by claim 7, wherein said plurality of silane molecules having multi branched chains are crosslinked with a T type cross link that hardens into a pseudo polymer network during gypsum cure.

13. A gypsum board as recited by claim 7, wherein said plurality of silane molecules having multi branched chains are crosslinked with a Q type cross link that hardens into the pseudo polymer network during gypsum cure.

14. A gypsum board as recited by claim 1, wherein said silane based sizing composition is multi branched with a hydrophobic termination attached to said glass fiber and said multi branched sizing diffuses into said wet gypsum mix hardening during gypsum cure cycle into a pseudo polymeric network in the microstructurally identifiable bond region adjacent to said glass fiber reinforcement within said gypsum matrix.

15. A gypsum board as recited by claim 1, wherein said silane based sizing composition has a thickness ranging from about 0.25 to 6 microns.

16. A gypsum board, comprising:
a. a gypsum matrix having a top and a bottom;
b. a first facer sheet placed on the bottom of said gypsum matrix;
c. a second facer sheet placed on the top of said gypsum matrix; and
d. at least one mat composed of glass fibers coated with a silane based sizing composition, and being disposed within said gypsum matrix before said board is subjected to a curing process,
said mat being operative to increase strength, flexure resistance and nail pull out resistance of said gypsum board.

17. A gypsum board as recited by claim 16, wherein each of said first and said second facer sheets comprises Kraft paper.

18. A gypsum board as recited by claim 16, wherein said gypsum matrix comprises a gypsum mix including calcium sulphate hemihydrate (CaSO4.1/2H₂O), calcium sulphate anhydrite (CaSO4), hydraulic setting cement and water.

19. A gypsum board as recited by claim 16, wherein said hydraulic setting cement is selected from the group consisting of Portland cements, sulphate resisting cements, blast furnace cements, pozzolanic cements, and high alumina cements.

20. A gypsum board as recited by claim 16 wherein said silane based sizing composition coating comprises polymethylsiloxane.

21. A gypsum board as recited by claim 16, wherein said silane based sizing composition includes a hydrophobic moiety whereby said hydrophobic moiety functions to cause said silane based sizing composition to adhere to said glass fibers.

22. A gypsum board as recited by claim 16, wherein said silane based sizing composition includes a hydrophilic moiety whereby said hydrophilic moiety interacts with water present in said gypsum mix.

23. A gypsum board as recited by claim 16, wherein said hydrophobic moiety is selected from a group consisting of an amino group, a methacryl group and an alkyl functional group.

24. A gypsum board as recited by claim 16, wherein said hydrophilic moiety comprises poly(ethylene) oxide.

25. A gypsum board as recited by claim 16, wherein said silane based sizing composition comprises a plurality of silane molecules having single or cross linked polydimethylsiloxane chains.

26. A gypsum board as recited by claim 16, wherein said silane based sizing composition comprises a plurality of silane molecules having multi branched chains.

27. A gypsum board as recited by claim 26, wherein said plurality of silane molecules having multi branched chains are crosslinked with a T type cross link that hardens the pseudo polymer network during gypsum cure.

28. A gypsum board as recited by claim 26, wherein said plurality of silane molecules having multi branched chains are crosslinked with a Q type cross link that hardens the pseudo polymer network during gypsum cure.

29. A gypsum board as recited by claim 16, wherein said silane based sizing composition is multi branched with a hydrophobic termination that attaches to said glass fiber and said multi branched sizing diffuses into said wet gypsum mix hardening during gypsum cure cycle into a pseudo polymeric network in the microstructurally identifiable bond region adjacent to said glass fiber reinforcement within said gypsum matrix.

30. A gypsum board as recited by claim 16, wherein said silane based sizing composition is from 0.25 to 6 microns thick.

31. A process for manufacturing a gypsum board, comprising the steps of:
a. coating a silane based sizing composition onto a plurality of glass fibers;
b. forming an aqueous slurry comprising at least one member selected from the group consisting of anhydrous calcium sulphate, calcium sulphate hemi-hydrate, hydraulic setting cement and water;
c. mixing said plurality of glass fibers having a coating of silane based sizing composition with said aqueous slurry;
d. distributing said aqueous slurry to form a layer on said first facer;
e. applying said second facer onto the top of said slurry layer;
f. separating the resultant laminate into individual gypsum boards; and
g. drying said gypsum boards during a gypsum cure cycle.

32. A process for manufacturing a gypsum board, comprising the steps of:
a. forming an aqueous slurry comprising at least one member selected from the group consisting of anhydrous calcium sulphate, calcium sulphate hemi-hydrate, hydraulic setting cement and water;
b. distributing said aqueous slurry to form a layer on said first facer;
c. incorporating organized structures including mats of silane based sizing composition coated reinforcing glass fibers into said aqueous slurry layer;
d. applying said second facer onto the top of said slurry layer;
e. separating the resultant laminate into individual gypsum boards; and
f. drying said gypsum boards during a gypsum cure cycle.
